(19) United States
(12) Patent Application Publication
(10) Pub. No.: US 2017/0001237 A1
(43) Pub. Date: Jan. 5, 2017

(54) METHOD FOR PRODUCING A SHAFT-HUB CONNECTION

(71) Applicant: IAV GmbH Ingenieurgesellschaft Auto und Verkehr, Berlin (DE)

(72) Inventors: Heiko NEUKIRCHNER, Chemnitz (DE); Andreas WERLER, Zwickau (DE); Stefan KUEHN, Augustusburg (DE); Peer LEICHSENRING, Chemnitz (DE)

(21) Appl. No.: 15/113,442

(22) PCT Filed: Jan. 20, 2015
(86) PCT No.: PCT/DE2015/000017

§ 371 Date: Jul. 22, 2016

(30) Foreign Application Priority Data
Jan. 22, 2014 (DE) 10 2014 000 809.6

(51) Int. Cl. B21K 1/08; F16C 3/035; F16D 1/064; F16B 4/00

(52) U.S. Cl. CPC B21K 1/08; F16B 4/004; F16C 3/035; F16D 1/064

(57) ABSTRACT

A method for producing a shaft-hub connection having a secondary bearing seat that is on the shaft and that is axially at a distance from the shaft-hub connection includes determining a dimensional deviation relative to a final dimension of the bearing seat as a derivative action for a deformation of the bearing seat. A final machining of the bearing seat is performed with the dimensional deviation before assembly of the shaft-hub connection. Then, the shaft-hub connection is produced by a press-fit connection. The deformation of the shaft caused by the shaft-hub connection deforms the bearing seat to the final dimension, in that the deformation of the shaft compensates for the dimensional deviation of the bearing seat.

### CROSS-REFERENCE TO PRIOR APPLICATIONS

This application is a U.S. National Stage Application under 35 U.S.C. §371 of International Application No. PCT/DE2015/000017 filed on January 20, 2015, and claims benefit to German Patent Application Nos. DE 10 2014 000 809.6 filed on Jan. 22, 2014. The International Application was published in German on Jul. 30, 2015 as WO 2015/110113 A1 under PCT Article 21(2).

### FIELD

The present invention relates to a method for the production of a shaft-hub connection.

### BACKGROUND

It is a known procedure to configure shaft-hub connections as non-positive or positive connections, especially also as combinations of non-positive and positive connections, by means of which shafts and hubs can be tightly connected to each other. In this context, the configuration of the shaft-hub connection has an influence on the torque that can be transmitted via the shaft-hub connection.

It is a known procedure to configure crankshafts and camshafts for internal combustion engines as one-piece shafts. These one-piece shafts are mounted on friction bearings in the internal combustion engine. In the case of crankshafts, the connecting rod is also mounted on friction bearings. As an alternative, solutions are also known in which antifriction mountings having split antifriction bearings are used instead of friction bearings in order to reduce the friction of the bearing during the operation of the internal combustion engine. The use of split antifriction bearings is necessary here since this avoids the need for assembly work involving sliding onto the bearing seat because of secondary components such as crank webs in the case of crankshafts or cams in the case of camshafts. Such split antifriction bearings, however, have a number of drawbacks that have a negative effect on the service life of the antifriction bearings.

Assembled crankshafts and assembled camshafts have been developed in order to permit the use of non-split antifriction bearings. The assembled shafts consist of several individual parts, whereby positive and/or non-positive connections are provided in order to ensure the transmission of the torque. The individual parts can already have largely undergone final machining before the assembly.

German patent specification DE 891 641 describes a method for the production of crankshafts consisting of several interlocking parts by shrinking them in place. In this manner, the surface of the hole is shaped onto the inserted journal. As a result, the fit-in cross sections, which diverge from a circular shape, can be produced much more easily. The parts that are to be fitted in are shaped by shrinking them onto each other very tightly by thermally relaxing the parts without moving them relative to each other.

German published examined application DE 1 172 520 discloses a method for the production of half assembled or fully assembled crankshafts. A sequence of machining steps and joining steps are described that are intended to overcome the problem of journals that are not aligned with each other.

If one-piece antifriction bearings are provide for the assembled shafts, then the antifriction bearings are fully machined before the assembly of the assembled shafts so that the appertaining antifriction bearing can be placed onto the appertaining antifriction bearing seat before the assembly of the assembled shaft. Subsequently, the secondary components are assembled and further machined, if applicable. This approach would avoid not only positioning errors and alignment errors, but at the same time, also deformations of the individual bearings caused by the press-fit connection.

German preliminary published application DE 196 24 048 A1 discloses a method for the production of a frictional shaft-hub connection. For this purpose, a round component is first plastically deformed so as to be oval or polygonal, and subsequently elastically rounded. While the elastic rounding is retained, the shaft-hub connection is assembled so that the components are connected to each other by means of a press-fit connection when they rebound to the oval or polygonal shape.

Due to non-positive connections and the associated elastic or plastic deformations, however, deformations in the antifriction bearing seat can also occur if the non-positive connection of the secondary components has an effect quite near the antifriction bearing seat. These deformations in the vicinity of the antifriction bearing seat, in turn, can cause deformations and consequently elevated stresses in the antifriction bearing, thereby having a negative impact on the load-bearing capacity and on the service life.

European patent specification EP 0 960 287 B1 discloses a method for the production of a shaft-hub connection that serves to secure antifriction bearings onto a shaft. For this purpose, a rolling tool is used to generate an elevation on the shaft surface by means of plastic deformation, so that the elevation comes into contact with an axial surface of the antifriction bearing, thereby preventing axial movement.

### SUMMARY

In an embodiment, the present invention provides a method for producing a shaft-hub connection having a secondary bearing seat that is on the shaft and that is axially at a distance from the shaft-hub connection. A dimensional deviation relative to a final dimension of the bearing seat is determined as a derivative action for a deformation of the bearing seat. A final machining of the bearing seat is performed with the dimensional deviation before assembly of the shaft-hub connection. Then, the shaft-hub connection is produced by a press-fit connection. The deformation of the shaft caused by the shaft-hub connection deforms the bearing seat to the final dimension, in that the deformation of the shaft compensates for the dimensional deviation of the bearing seat.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic depiction of a conventional shaft (1)-hub (2) connection with a cylindrical profile;

FIG. 2 is a schematic depiction of a shaft (1)-hub (2) connection according to an embodiment of the invention with a cylindrical profile;

FIG. 3 is a schematic depiction of a conventional shaft (1)-hub (2) connection with a polygonal profile; and

FIG. 4 is a schematic depiction of a shaft (1)-hub (2) connection according to an embodiment of the invention with a polygonal profile.

### DETAILED DESCRIPTION

In an embodiment, the invention provides a method for the production of a shaft-hub connection in which the deformation of a bearing seat is reduced as a result of a secondary non-positive connection.

In an embodiment, the invention provides an advantageous method for the production of a shaft-hub connection which reduces the deformation caused by the shaft-hub connection relative to a shape tolerance of a secondary bearing seat that is on the shaft and that is at a distance from the shaft-hub connection in the axial direction. In this manner, the machining of the secondary bearing seat subsequent to the assembly of the shaft-hub connection can be eliminated.

The shaft-hub connection is configured as a press-fit connection, whereby purely non-positive connections and pre-tensioned positive connections are included. The term “pre-tensioned positive connections” refers to connections that are configured as non-positive connections in combination with positive connections.

The advantageous method according to an embodiment of the invention for the production of a shaft-hub connection provides that, initially, a dimensional deviation relative to the final dimension of the bearing seat is determined as the derivative action for a deformation of the bearing seat, and the bearing seat undergoes final machining with the dimensional deviation before the assembly of the shaft-hub connection. Subsequently, the shaft-hub connection is produced by means of a press-fit connection configured as a purely non-positive connection or as a pre-tensioned positive connection, and the deformation of the shaft resulting from the shaft-hub connection deforms the bearing seat to its final dimension, whereby the deformation of the shaft compensates for the dimensional deviation of the bearing seat.

For this purpose, before the assembly of the shaft-hub connection, the bearing seat is machined in such a way that the bearing seat is brought to its desired final dimension by means of the deformation resulting from the secondary non-positive shaft-hub connection. The final dimension is subject to the determined shape tolerances that are necessary for a bearing seat. Depending on the shape of the geometric shaft and hub configuration, on the non-positive connection, on the material pairing used as well as on the joining method, before the shaft-hub connection is produced, at least partial areas of the bearing seat undergo final machining with the defined dimensional deviation relative to the desired final dimension of the bearing seat. Due to the final machining with the predefined dimensional deviation, the bearing seat initially does not comply with the required shape tolerance. Only the subsequent assembly of the shaft-hub connection then eliminates the dimensional deviation resulting from the deformation caused by the secondary non-positive connection, and the bearing seat assumes its desired final dimension without any further machining. The elimination of the dimensional deviation in the vicinity of the bearing seat can be ascribed to the component deformation resulting from the secondary non-positive connection relative to the bearing seat. Consequently, the dimensional deviation of the bearing seat should be understood as a derivative action that is used up by the deformation of the bearing seat resulting from the secondary non-positive shaft-hub connection. After the secondary non-positive shaft-hub connection has been produced, the bearing seat complies with the required shape tolerance.

The press-fit connection of the shaft-hub connection can be configured as a lengthwise press-fit connection or a crosswise press-fit connection, especially as a shrink connection or an expansion connection. The press-fit connection brings about a permanent elastic or permanent elastic-plastic deformation of the shaft and of the hub in the vicinity of the shaft-hub connection as well as in the vicinity of the secondary bearing seat.

In the case of crankshafts, the shaft-hub connection relates especially to the connection between the crank web and the connecting rod journal and/or between the crank web and the main journal wherein a bearing seat is provided in the axial direction next to the shaft-hub connection.

In the case of camshafts, the shaft-hub connection relates especially to the connection between the cam and the main camshaft body, wherein a bearing seat is provided in the axial direction next to the shaft-hub connection.

Here, the bearing seat can be configured to hold bearings, especially to hold an antifriction bearing or friction bearing shells. As an alternative, the bearing seat itself can be configured as a bearing, especially instead of the inner antifriction bearing ring of an antifriction bearing, or else as a friction bearing. If the bearing seat is configured to hold a bearing, especially antifriction bearings or non-split friction bearing shells, then the bearing is already mounted on the bearing seat before the secondary shaft-hub connection has been produced.

The dimensional deviation of the bearing seat before the assembly of the secondary shaft-hub connection varies in the lengthwise direction of the bearing seat, whereby, starting from an edge area of the bearing seat, the dimensional deviation decreases as the distance increases from the secondary shaft-hub connection. In addition, the dimensional deviation of the bearing seat can also vary in the circumferential direction if the geometric configuration of the shaft and/or of the hub diverge from a circular shape.

The dimensional deviation of the bearing seat is dimensioned in such a way that the deformation that is to be expected as a result of the secondary shaft-hub connection leads to the reduction of the dimensional deviation, and thus the final dimension required for the bearing seat is achieved. Particularly important aspects for the dimensioning of the dimensional deviation are the profile of the shaft-hub connection, the geometric configuration of the shaft and the hub as well as the material pairing used when it comes to the material properties. The dimensional deviation can be configured as an undersize or as an oversize. The dimensional deviation is configured as an oversize, at least in partial areas of the bearing seat, and is configured to decrease towards the center of the bearing seat.

If the shaft-hub connection is configured as a cylinder profile, then, if the hub thickness is the same, the bearing seat is configured with an oversize that remains constant in the radial direction and that, starting from the edge area, decreases in the axial direction towards the center of the bearing seat.

If the shaft-hub connection is configured as a profile that diverges from a cylindrical profile, for example, as a polygonal profile or some other profile shape, then the bearing seat is configured with an undersize and/or an oversize that changes in the radial and axial directions, whereby, starting from the edge area, the undersize and/or oversize decreases in the axial direction towards the center of the bearing seat. This results from the irregular deformation of the polygonal profile over the circumference and from the associated irregular deformation of the bearing seat, which is countered by a dimensional deviation that is irregular over the circumference.

Other factors that influence the dimensional deviation and that have to be taken into consideration are the actually effective wall thickness of the hub as well as a reciprocal influencing of several shaft-hub connections on a shared shaft with a bearing seat between them or else within a shared hub, if these several shaft-hub connections are arranged sufficiently close to each other to reciprocally influence each other.

The determination of the dimensional deviation can be carried out by pre-calculating the deformation that is to be expected, preferably by using computer programs. Appropriate tools for solid body simulation can be used for this purpose. The actual deformation can also be determined by experiments based on a comparison of the shape of the bearing seat before and after the shaft-hub connection has been produced.

### EMBODIMENT

### Cylindrical Profile

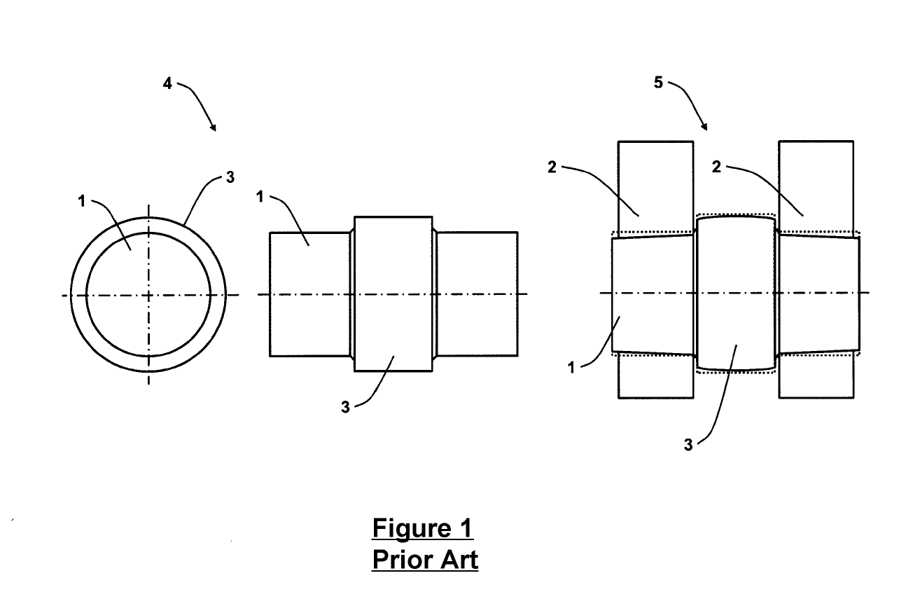

In a conventional shaft (1)-hub (2) connection as a press-fit connection with a cylindrical profile, shown in simplified form in FIG. 1, deformations occur to the shaft (1) and to the hub (2) as a result of the press-fit connection. A secondary bearing seat (3) that is at an axial distance from the shaft (1)-hub (2) connection is deformed, starting from a finished part state (4), to a deformed assembled state (5). Owing to the deformation of the bearing seat (3), the shape of the bearing seat (3) no longer complies with the required shape tolerances.

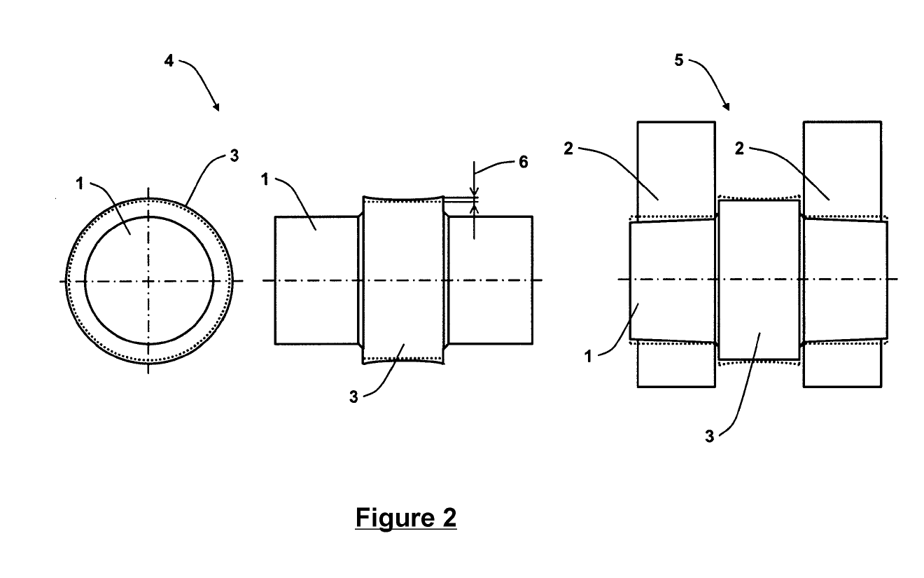

The method for the production of a shaft (1)-hub (2) connection as a press-fit connection with a cylindrical profile, which is advantageous according to an embodiment of the invention, shown in simplified form in FIG. 2, provides that the secondary bearing seat (3) that is at an axial distance from the shaft (1)-hub (2) connection is machined before the assembly of the shaft (1)-hub (2) connection in such a way that the bearing seat (3) is only then brought to its desired final dimension by means of the deformation resulting from the press-fit connection so as to comply with the required shape tolerances.

For this purpose, before the secondary shaft (1)-hub (2) connection is produced, the bearing seat (3) is machined on the shaft (1) with a defined dimensional deviation relative to the desired final dimension so as to form a finished part state (4), whereby the dimensional deviation was determined from the deformation that is to be expected. Due to the final machining with the predefined dimensional deviation, the bearing seat (3) initially does not comply with the required shape tolerance.

The configuration of the shaft (1)-hub (2) connection as a press-fit connection in the form of a cylindrical profile gives rise to a dimensional deviation that remains constant over the circumference of the bearing seat (3) and that, starting from the edge area of the bearing seat (3), decreases as the distance from the secondary shaft (1)-hub (2) connection increases in the lengthwise direction. The dimensional deviation is configured to remain constant over the circumference, since the cylindrical profile gives rise to a deformation, particularly a diameter reduction, that remains constant over the circumference. In this context, in simplified terms, a constant thickness of the hub (2) is assumed. Consequently, the dimensional deviation is always configured as an oversize (6) that decreases towards the center of the bearing seat (3) in order to compensate for the deformation resulting from the press-fit connection.

Only the subsequent assembly of the shaft (1)-hub (2) connection then eliminates the dimensional deviation resulting from the deformation by the secondary press-fit connection of the shaft (1)-hub (2) connection, and the bearing seat (3) in the assembled state (5) assumes its desired final dimension without any further machining, thereby now complying with the required shape tolerances.

### EMBODIMENT

### Polygonal Profile

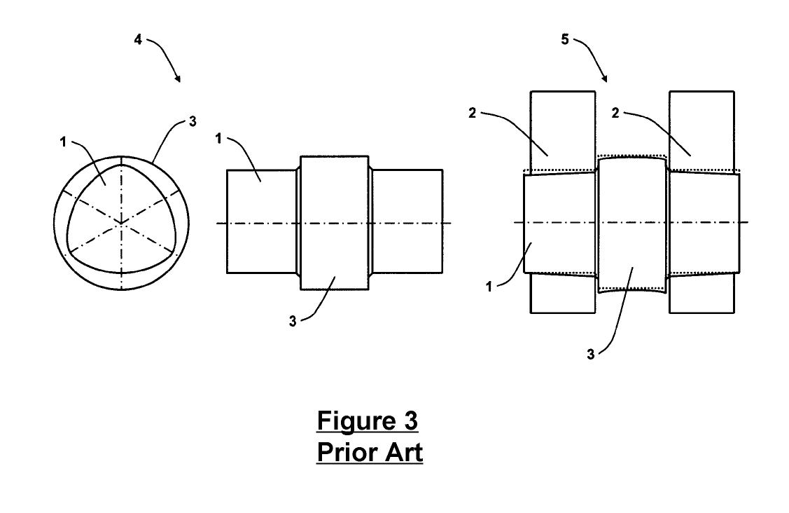

In a conventional shaft (1)-hub (2) connection as a press-fit connection with a polygonal profile, shown in simplified form in FIG. 3, deformations occur to the shaft (1) and to the hub (2) as a result of the press-fit connection. A secondary bearing seat (3) that is at an axial distance from the shaft (1)-hub (2) connection is deformed, starting from a finished part state (4), to a deformed assembled state (5). Owing to the deformation of the bearing seat (3), the shape of the bearing seat (3) no longer complies with the required shape tolerances.

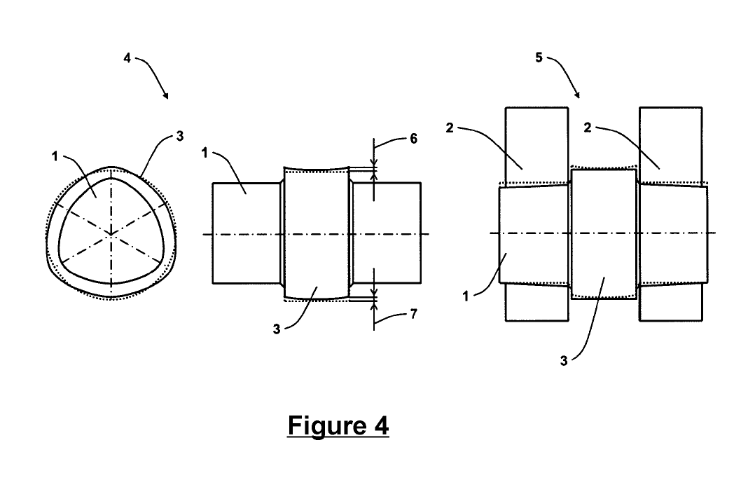

The method for the production of a shaft (1)-hub (2) connection as a press-fit connection with a polygonal profile, which is advantageous according to an embodiment of the invention, shown in simplified form in FIG. 4, unlike the preceding embodiment, provides that the dimensional deviations have been adapted to the expected deformations by the polygonal profile.

The configuration of the shaft (1)-hub (2) connection as a press-fit connection in the form of a polygonal profile gives rise to a dimensional deviation that extends over the circumference of the bearing seat (3), that is irregular and that, starting from the edge area to the secondary shaft (1)-hub (2) connection, decreases in the lengthwise direction of the bearing seat (3) as the distance increases. Here, the dimensional deviation is configured as an oversize (6) in partial areas and configured as an undersize (7) in partial areas so as to decrease towards the center of the bearing in order to compensate for the deformation resulting from the press-fit connection with a polygonal profile. Due to the press-fit connection, the polygonal profile is deformed over the circumference in different ways, thereby approaching the cylindrical profile. This results in radius decreases in the bearing seat (3) in partial areas as well as radius increases in partial areas that are provided by the dimensional deviation as an oversize (6) and as an undersize (7).

Before the shaft (1)-hub (2) connection is produced, the bearing seat (3) is machined with the defined dimensional deviation to form a finished part state (4). Only the subsequent assembly of the shaft (1)-hub (2) connection then eliminates the dimensional deviation that results from the deformation caused by the secondary press-fit connection of the shaft (1)-hub (2) connection, and the bearing seat (3) assumes its desired final dimension in the deformed assembled state (5) without any further machining of its shape and now complies with the required shape tolerance.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 shaft
2 hub
3 bearing seat
4 finished part state
5 assembled state
6 oversize
7 undersize

1. A method for producing a shaft-hub connection having a secondary bearing seat that is on the shaft and that is axially at a distance from the shaft-hub connection, the method comprising:
determining a dimensional deviation relative to a final dimension of the bearing seat as a derivative action for a deformation of the bearing seat;
performing a final machining of the bearing seat with the dimensional deviation before assembly of the shaft-hub connection; and then
producing the shaft-hub connection by a press-fit connection,
wherein deformation of the shaft caused by the shaft-hub connection deforms the bearing seat to the final dimension, in that the deformation of the shaft compensates for the dimensional deviation of the bearing seat.

2. The method according to claim 1, wherein a shape tolerance needed for the bearing seat is defined, wherein the bearing seat with the dimensional deviation does not comply with the defined shape tolerance before the assembly of the shaft-hub connection, and wherein the bearing seat with the dimensional deviation complies with the defined shape tolerance after the assembly of the shaft-hub connection.

3. The method according to claim 1, wherein the dimensional deviation is determined depending on at least one of a geometric shaft and hub configuration, a non-positive connection, a material pairing used and a joining method.

4. The method according to claim 1, wherein the dimensional deviation is configured as an oversize, at least in partial areas.

5. The method according to claim 1, wherein, starting from an edge area of the bearing seat, the dimensional deviation decreases as distance increases from the shaft-hub connection in a lengthwise direction of the bearing seat.
